(19) United States
(12) Patent Application Publication
(10) Pub. No.: US 2026/0186558 A1
(43) Pub. Date: Jul. 2, 2026

(54) CONTROL CIRCUIT AND COMPUTING CIRCUIT

(71) Applicant: Nuvoton Technology Corporation, Hsinchu Science Park (TW)

(72) Inventor: Yung-Chi LAN, Taichung City (TW)

(21) Appl. No.: 19/432,506

(22) Filed: Dec. 24, 2025

(30) Foreign Application Priority Data
Dec. 31, 2024 (TW) 113151617

(51) Int. Cl. G06F 1/3296; G06F 1/3206

(52) U.S. Cl. CPC G06F 1/3296; G06F 1/3206

(57) ABSTRACT

A control circuit including a processing circuit, a function circuit, a voltage regulator, and a monitoring circuit is provided. The voltage regulator uses a switching signal to adjust the operating voltage provided to the processing circuit and the function circuit. The monitoring circuit determines the total current of the processing circuit and the function circuit according to the switching signal. In response to the total current of the processing circuit and the function circuit being higher than a heavy threshold value, the monitoring circuit directs the function circuit to operate in an energy-saving mode. In response to the total current of the processing circuit and the function circuit being lower than a light threshold value, the monitoring circuit directs the function circuit to operate in a performance mode.

### CROSS REFERENCE TO RELATED APPLICATIONS

This Application claims priority of Taiwan Patent Application No. 113151617, filed on Dec. 31, 2024, the entirety of which is incorporated by reference herein.

### BACKGROUND OF THE INVENTION

### Field of the Invention

The present invention relates to a control circuit, and, in particular, it relates to a control circuit capable of adjusting power consumption.

### Description of the Related Art

With the advancement of technology, the types and functions of electronic devices have increased. An electronic device usually has many electronic components inside. When all these electronic components are fully operational, the total power consumption of the electronic components will increase rapidly. When the total power consumption exceeds a predetermined value, the electronic device may overheat.

### BRIEF SUMMARY OF THE INVENTION

In accordance with an embodiment of the disclosure, a control circuit comprises processing circuit, a function circuit, a voltage regulator, and a monitoring circuit, The function circuit operates in a performance mode or an energy-saving mode. The function circuit has a first efficiency value in the performance mode and has a second efficiency value in the energy-saving mode. The first efficiency value is higher than the second efficiency value. The voltage regulator provides an operating voltage to the processing circuit and first function circuit and uses a switching signal to adjust the operating voltage. The monitoring circuit determines the total current of the processing circuit and the function circuit according to the switching signal. In response to the total current of the processing circuit and the function circuit being higher than a heavy threshold value, the monitoring circuit directs the function circuit to operate in the energy-saving mode. In response to the total current of the processing circuit and the function circuit being lower than a light threshold value, the monitoring circuit directs the function circuit to operate in the performance mode.

In accordance with another embodiment of the disclosure, a computing circuit comprises a first multiplier, a first multiplexer, a first adder, a first D-type flip-flop, a second multiplier, a second multiplexer, a second adder, and a second D-type flip-flop. The first multiplier generates a first processed value by multiplying a first input value by a second input value. The first multiplexer provides an external value or a first output value as a second output value. The first adder adds the first processed value to the second output value to generate a second processed value. The first D-type flip-flop generates the first output value according to the second processed value. The second multiplier generates a third processed value by multiplying a third input value by a fourth input value. The second multiplexer provides the second processed value or a third output value as a fourth output value. The second adder adds the third processed value to the fourth output value to generate a fourth processed value. The second D-type flip-flop generates the third output value according to the fourth processed value. In response to the first multiplexer providing the external value as the second output value, the second multiplexer provides the second processed value as the fourth output value and the first D-type flip-flop and the second D-type flip-flop stop working. In response to the first multiplexer providing the first output value as the second output value, the second multiplexer provides the third output value as the fourth output value.

In accordance with another embodiment of the disclosure, a computing circuit comprises a first input circuit, a first multiplier, a first multiplexer, a first adder, a first D-type flip-flop, a first logic circuit, a second input circuit, a second multiplier, a second multiplexer, a second adder, a second D-type flip-flop, a second logic circuit. The first input circuit outputs a first input value and a first weight value according to a first clock signal. The first multiplier generates a first processed value by multiplying the first input value by a first weight value. The first multiplexer provides an external value or the first processed value as a first output value. The first adder adds the first output value to a second output value to generate a second processed value. The first D-type flip-flop generates a third output value according to the second processed value. The first logic circuit generates the second output value according to a first reset signal and the third output value. The second input circuit outputs a second input value and a second weight value according to a second clock signal. The second multiplier generates a third processed value by multiplying the second input value by the second weight value. The second multiplexer provides the third output value or the third processed value as a fourth output value. The second adder adds the fourth output value to a fifth output value to generate a fourth processed value. The second D-type flip-flop generates a sixth output value according to the fourth processed value. The second logic circuit generates the fifth output value according to a second reset signal and the sixth output value.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control circuit according to various aspects of the present disclosure.

FIG. 2 is a schematic diagram of an exemplary embodiment of a voltage regulator according to various aspects of the present disclosure.

FIG. 3 is a schematic diagram showing the electrical characteristics of a switching signal according to various aspects of the present disclosure.

FIG. 4 is a schematic diagram of another exemplary embodiment of the control circuit according to various aspects of the present disclosure.

FIG. 5 is a schematic diagram of an exemplary embodiment of a computing circuit according to various aspects of the present disclosure.

FIG. 6 is a schematic diagram of another exemplary embodiment of the computing circuit according to various aspects of the present disclosure.

FIG. 7 is a schematic diagram of the operation of the computing circuit according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

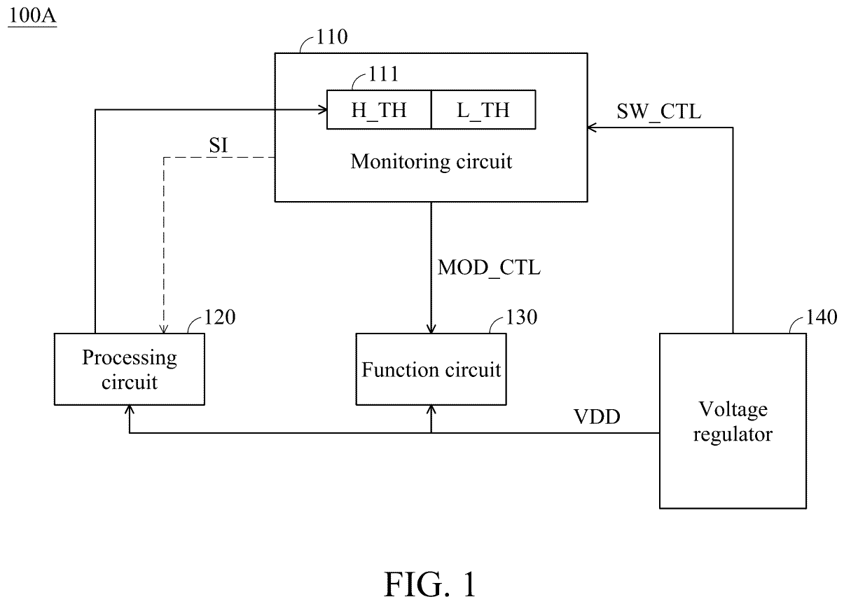

FIG. 1 is a schematic diagram of an exemplary embodiment of a control circuit according to various aspects of the present disclosure. The control circuit 100A comprises a monitoring circuit 110, a processing circuit 120, a function circuit 130 and a voltage regulator 140. In one embodiment, the control circuit 100A is a micro-controller unit (MCU) or a micro-processing unit (MPU).

The processing circuit 120 operates according to the operating voltage VDD. In this embodiment, the maximum operating current of the processing circuit 120 is a fixed value, such as 50 mA. The type of processing circuit 120 is not limited in the present disclosure. In one embodiment, the processing circuit 120 is a central processing unit (CPU). In other embodiments, the control circuit 100A may have more CPUs.

The function circuit 130 operating according to the operating voltage VDD. In this embodiment, the function circuit 130 may operate in a performance mode or an energy-saving mode. In the performance mode, the efficiency (referred to as a first efficiency value) of the function circuit 130 is good, but the maximum operating current (referred to a first current) is high. In the energy-saving mode, the efficiency (referred to as a second efficiency value) of the function circuit 130 is low, but the maximum operating current (referred to as a second current) is low. In such cases, the first efficiency value is higher than the second efficiency value. The first current is higher than the second current. For example, in the performance mode, the maximum operating current of the function circuit 130 is 60 mA, and in the energy-saving mode, the maximum operating current of the function circuit 130 is 20 mA. The structure of the function circuit 130 is not limited in the present disclosure. Any circuit can be used as a function circuit 130.

The number of operation modes of the function circuit 130 is not limited in the present disclosure. In other embodiments, the function circuit 130 has more operation modes. In different operation modes, the function circuit 130 has different efficiency values and different maximum operating currents. When the efficiency value of the function circuit 130 is higher, the maximum operating current of the function circuit 130 is also higher. In some embodiments, the processing circuit 120 also has different operation modes. In different operation modes, the processing circuit 120 has different efficiency value and different maximum operating currents.

The voltage regulator 140 provides the operating voltage VDD to the processing circuit 120 and the function circuit 130 and uses a switching signal SW_CTL to adjust the operating voltage VDD and maintain the operating voltage VDD in a target level. For example, when the total current of the processing circuit 120 and the function circuit 130 increases, the operating voltage VDD may be lower than the target level. Therefore, the voltage regulator 140 increases the operating voltage VDD. When the total current of the processing circuit 120 and the function circuit 130 reduces, the operating voltage VDD may be higher than the target level. Therefore, the voltage regulator 140 reduces the operating voltage VDD. The circuit structure of voltage regulator 140 is not limited in the present disclosure. In one embodiment, the voltage regulator 140 may be a DC-DC converter.

The monitoring circuit 110 detects the total current of the processing circuit 120 and the function circuit 130 according to the switching signal SW_CTL. When the total current of the processing circuit 120 and the function circuit 130 is higher than a heavy threshold value H_TH, the monitoring circuit 110 directs the processing circuit 120, the function circuit 130, or both to operate in an energy-saving mode. In such cases, the processing circuit 120 cannot operate in an energy-saving mode and the function circuit 130 is capable of operating in an energy-saving mode, the monitoring circuit 110 directs the function circuit 130 to operate in an energy-saving mode. In other embodiments, if the processing circuit 120 is capable of operating in an energy-saving mode, the monitoring circuit 110 may direct the processing circuit 120, the function circuit 130, or both to operate in an energy-saving mode according to an priority order.

When the total current of the processing circuit 120 and the function circuit 130 is lower than a light threshold value L_TH, the monitoring circuit 110 directs the processing circuit 120, the function circuit 130, or both to operate in a performance mode. In such cases, since the function circuit 130 is capable of operating in a performance mode, the function circuit 130 enters an performance mode. In other embodiments, if the processing circuit 120 is capable of operating in a performance mode, the monitoring circuit 110 may direct the processing circuit 120, the function circuit 130, or both to operate in a performance mode according to an priority order.

In some embodiments, when the total current of the processing circuit 120 and the function circuit 130 is higher than the heavy threshold value H_TH, the monitoring circuit 110 requires the circuit with lower priority to operate in an energy-saving mode according to a priority order. In such cases, since the performance of the circuit with higher priority remains unchanged, the control circuit 100A can still operate normally. However, when the total current of the processing circuit 120 and the function circuit 130 is lower than the light threshold value L_TH, the monitoring circuit 110 requires the circuit with higher priority to operate in a performance mode, thereby greatly improving the performance of the control circuit 100A.

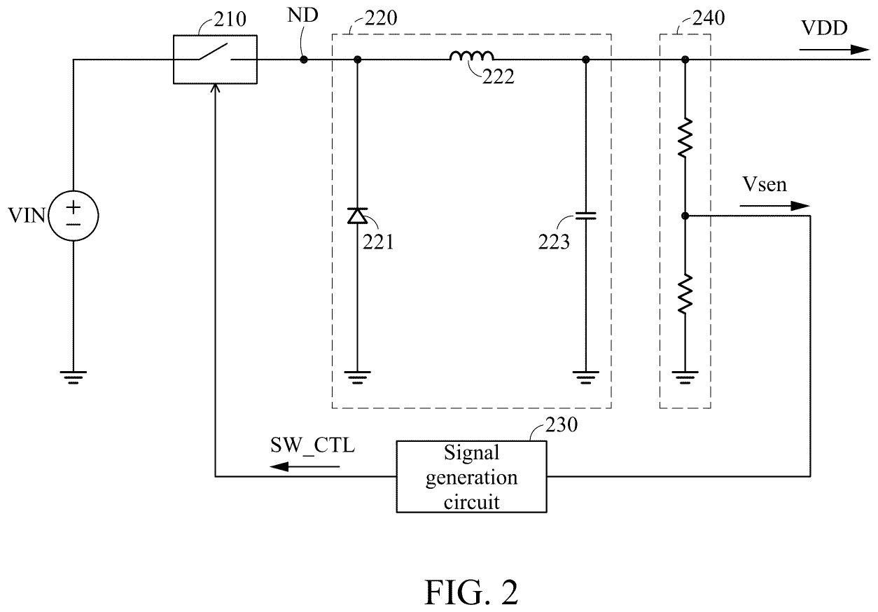

FIG. 2 is a schematic diagram of an exemplary embodiment of a voltage regulator according to various aspects of the present disclosure. The voltage regulator 140 converts an input voltage VIN to generate the operating voltage VDD. The operating voltage VDD may be higher than or less than the input voltage VIN. When the voltage regulator 140 is a boost converter, the operating voltage VDD is higher than the input voltage VIN. When the voltage regulator 140 is a buck converter, the operating voltage VDD is less than the input voltage VIN. As shown in FIG. 2, the voltage regulator 140 comprises a transmission circuit 210, an energy storage circuit 220 and a signal generation circuit 230.

The transmission circuit 210 transmits the input voltage VIN to a node ND according to the switching signal SW_CTL. For example, when the switching signal SW_CTL is at a first level (e.g., a high level), the transmission circuit 210 transmits the input voltage VIN to the node ND. When the switching signal SW_CTL is at a second level (e.g., a low level), the transmission circuit 210 stops transmitting the input voltage VIN to the node ND. The structure of transmission circuit 210 is not limited in the present disclosure. In one embodiment, the transmission circuit 210 is a switch which is controlled by the switching signal SW_CTL.

The energy storage circuit 220 is coupled to the node ND and provides the operating voltage VDD according to the voltage of the node ND. In one embodiment, the energy storage circuit 220 comprises a diode 221, an inductor 222, and a capacitor 223. When the voltage of the node is equal to the input voltage VIN, the input voltage VIN charges the capacitor 223 via the inductor 222. Therefore, the voltage of the capacitor 223 gradually increases. In such cases, the voltage of the capacitor 223 is provided as the operating voltage VDD. When the transmission circuit 210 stops transmitting the input voltage VIN to the node ND, the capacitor 223 is operated in a discharge mode. At this time, the voltage (i.e., the operating voltage VDD) of the capacitor 223 is gradually reduced.

The signal generation circuit 230 generates the switching signal SW_CTL according to the operating voltage VDD. When the operating voltage VDD is higher than a target level, the signal generation circuit 230 sets the switching signal SW_CTL to a first level. Therefore, the transmission circuit 210 stops transmitting the input voltage VIN to the node ND. At this time, the operating voltage VDD is gradually reduced. When the operating voltage VDD is too low, the signal generation circuit 230 sets the switching signal SW_CTL to a second level. Therefore, the transmission circuit 210 transmits the input voltage VIN to the node ND. At this time, the operating voltage VDD is gradually increased.

In some embodiments, the voltage regulator 140 further comprises a voltage divider circuit 240. The voltage divider circuit 240 processes the operating voltage VDD to generates a divided voltage Vsen. In such cases, the signal generation circuit 230 generates the switching signal SW_CTL according to the divided voltage Vsen. For example, when the divided voltage Vsen is higher than a reference voltage, the signal generation circuit 230 sets the switching signal SW_CTL to a first level. When the divided voltage Vsen is lower than the reference voltage, the signal generation circuit 230 sets the switching signal SW_CTL to a second level. In this embodiment, the signal generation circuit 230 is a pulse-width modulation (PWM) circuit.

In other embodiments, the signal generation circuit 230 is a pulse-frequency modulation (PFM) circuit or a pulse-skip modulation (PSM) circuit. For example, assume that the signal generation circuit 230 is a PFM circuit. When the divided voltage Vsen is higher than a reference voltage, the signal generation circuit 230 increases the amount of time that the switching signal SW_CTL stays in the first level. At this time, since the transmission circuit 210 stops transmitting the input voltage VIN to the node ND, the operating voltage VDD is gradually reduced. When the divided voltage Vsen is lower than a reference voltage, the signal generation circuit 230 reduces the amount of time that the switching signal SW_CTL stays in the first level. Since the amount of time that the signal generation circuit 230 stops transmitting the input voltage VIN to the node ND is reduced, the operating voltage VDD is gradually increased.

In another embodiment, the signal generation circuit 230 is a PSM circuit. In such cases, when the divided voltage Vsen is higher than a reference voltage, the signal generation circuit 230 sets the switching signal SW_CTL to a first level (e.g., a low level). At this time, the transmission circuit 210 stops transmitting the input voltage VIN to the node ND so that the operating voltage VDD is gradually reduced. When the divided voltage Vsen is lower than the reference voltage, the signal generation circuit 230 sets the switching signal SW_CTL to a second level. At this time, the transmission circuit 210 transmits the input voltage VIN to the node ND. Therefore, the operating voltage VDD is gradually increased.

The invention does not limit how the monitoring circuit 110 determines the total current of the processing circuit 120 and the function circuit 130. In one embodiment, the monitoring circuit 110 determines the total current of the processing circuit 120 and the function circuit 130 according to the electrical characteristics of the switching signal SW_CTL.

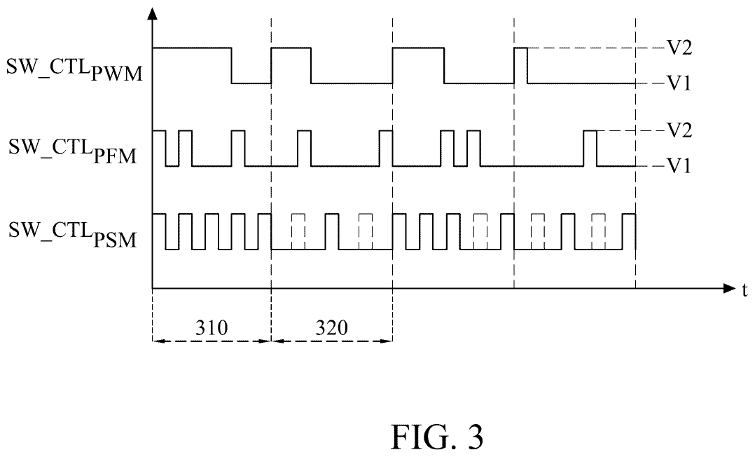

FIG. 3 is a schematic diagram showing the electrical characteristics of a switching signal according to various aspects of the present disclosure. When the signal generation circuit 230 is a PWM circuit, the switching signal SW_CTL generated by the signal generation circuit 230 is represented by the symbol SW_CTL_{PWM}. The signal generation circuit 230 adjusts the duration for which the switching signal SW_CTL_{PWM} is in the level V1 or V2 according to the divided voltage Vsen. For example, in period 310, when the total current of the processing circuit 120 and the function circuit 130 increases, the operating voltage VDD is reduced. When the divided voltage Vsen is less than a reference voltage, the signal generation circuit 230 reduces the duration for which the switching signal SW_CTL_{PWM} is in the level V1 or increases the duration for which the switching signal SW_CTL_{PWM} is in the level V2. Therefore, the operating voltage VDD is gradually increased.

In period 320, when the total current of the processing circuit 120 and the function circuit 130 is reduced, the operating voltage VDD is increased. When the divided voltage Vsen is higher than a reference voltage, the signal generation circuit 230 increases the duration for which the switching signal SW_CTL_{PWM} is in the level V1 or reduces the duration for which the switching signal SW_CTL_{PWM} is in the level V2. Therefore, the operating voltage VDD is gradually reduced.

When the signal generation circuit 230 is a PWM circuit, the monitoring circuit 110 determines the total current of the processing circuit 120 and the function circuit 130 according to the duration for which the switching signal SW_CTL_{PWM} is in the level V1 or V2.

The structure of monitoring circuit 110 is not limited in the present disclosure. In one embodiment, the monitoring circuit 110 comprises a counter (not shown) to count the duration for which the switching signal SW_CTL_{PWM} is in the level V1 or V2. When the count value of the counter is greater than a first value, it means that the total current of the processing circuit 120 and the function circuit 130 is higher than a heavy threshold value H_TH. Therefore, the monitoring circuit 110 directs at least one of the processing circuit 120 and the function circuit 130 to operate in an energy-saving mode. When the count value of the counter is less than a second value, it means that the total current of the processing circuit 120 and the function circuit 130 is lower than a light threshold value L_TH. Therefore, the monitoring circuit 110 directs at least one of the processing circuit 120 and the function circuit 130 to operate in a performance mode.

When the signal generation circuit 230 shown in FIG. 2 is a PFM circuit, the symbol SW_CTL_{PFM} shows the electrical characteristics of the switching signal SW_CTL. The signal generation circuit 230 adjusts the duration for which the switching signal SW_CTL_{PFM} is in the level V1 according to the divided voltage Vsen. For example, in period 310, the total current of the processing circuit 120 and the function circuit 130 is increased. Therefore, the operating voltage VDD is reduced. When the divided voltage Vsen is less than a reference voltage, the signal generation circuit 230 reduces the duration for which the switching signal SW_CTL_{PFM} is in the level V1. Therefore, the operating voltage VDD is gradually increased. In period 320, the total current of the processing circuit 120 and the function circuit 130 reduce. Therefore, the operating voltage VDD is increased. When the divided voltage Vsen is higher than a reference voltage, the signal generation circuit 230 increases the duration for which the switching signal SW_CTLPFM is in the level V1. Therefore, the operating voltage VDD is gradually reduced.

In such cases, the monitoring circuit 110 determines a variation of the total current of the processing circuit 120 and the function circuit 130 according to the duration of the switching signal SW_CTL_{PFM} being in the level V1. In one embodiment, the monitoring circuit 110 comprises a counter (not shown) to count the duration of the switching signal SW_CTL_{PFM} being in the level V1. In another embodiment, the monitoring circuit 110 counts the number of pulses of the switching signal SW_CTL_{PFM} in a detection period (e.g., the period 310 or 320). When the number of pulses of the switching signal SW_CTL_{PFM} is greater, it means that the total current of the processing circuit 120 and the function circuit 130 is higher. When the number of pulses of the switching signal SW_CTL_{PFM} is smaller, it means that the total current of the processing circuit 120 and the function circuit 130 is lower.

In other embodiments, in order to obtain a suitable detection period, during an initial period, the monitoring circuit 110 performs a simulation operation to direct the processing circuit 120 and the function circuit 130 to provide the highest performance. At this time, the total current of the processing circuit 120 and the function circuit 130 is a maximum value. The monitoring circuit 110 determines the time required for the energy storage circuit 220 to be charged 100 times (or referred to as a charging time). The monitoring circuit 110 stores the charging time in a non-volatile memory. Since the characteristics of energy storage circuits of different voltage regulators are different, the accuracy of the monitoring circuit 110 in evaluating the total current of the processing circuit 120 and the function circuit 130 can be greatly improved by detecting the charging time of the energy storage circuit via the monitoring circuit located in the same control circuit. In addition, the monitoring circuit 110 may adjust the charging time according to an external signal (e.g., a signal from the processing circuit 120). In one embodiment, the monitoring circuit 110 defines the durations of periods 310 and 320 according to the charging time of the energy storage circuit 220.

In some embodiment, when the signal generation circuit 230 is a PSM circuit, the symbol SW_CTL_{PSM} shows the electrical characteristics of the switching signal SW_CTL. The signal generation circuit 230 controls the number of pulses of the switching signal SW_CTL_{PSM} according to the divided voltage Vsen. For example, in period 310, the total current of the processing circuit 120 and the function circuit 130 increase. Therefore, the operating voltage VDD is reduced. When the divided voltage Vsen is less than a reference voltage, the signal generation circuit 230 sets the number of pulses of the switching signal SW_CTL_{PWM} is 5. In period 320, the total current of the processing circuit 120 and the function circuit 130 reduce. Therefore, the operating voltage VDD is increased. When the divided voltage Vsen is higher than a reference voltage, the signal generation circuit 230 reduces the number of pulses of the switching signal SW_CTL_{PSM}, such as from 5 to 2.

In such cases, the monitoring circuit 110 determines the total current of the processing circuit 120 and the function circuit 130 according to the number of pulses of the switching signal SW_CTL_{PSM}. In some embodiments, the monitoring circuit 110 comprises a counter (not shown) to count the number of pulses of the switching signal SW_CTL_{PSM}.

In other embodiments, after the monitoring circuit 110 reads the count value of the counter, the monitoring circuit 110 resets the counter so that the count value of the counter is equal to an initial value, such as the value 0. When the monitoring circuit 110 wants to determine the total current of the processing circuit 120 and the function circuit 130, the monitoring circuit 110 triggers the counter to perform a count operation. In such cases, after the counter is reset, it may take some time before it starts counting. In another embodiment, when the monitoring circuit 110 needs to know the total current of the processing circuit 120 and the function circuit 130, the monitoring circuit 110 resets the counter and triggers the counter immediately. In such cases, the counter starts performing the count operation immediately after being reset.

In some embodiments, the monitoring circuit 110 comprises another counter to count the duration that the total current of the processing circuit 120 and the function circuit 130 is higher than the heavy threshold value H_TH or less than the light threshold value L_TH. For example, when the duration that the total current of the processing circuit 120 and the function circuit 130 is higher than the heavy threshold value H_TH is higher than a predetermined value, the monitoring circuit 110 adjusts the operation mode of the processing circuit 120, the function circuit 130, or both to reduce the total current of the processing circuit 120 and the function circuit 130. However, when the duration that the total current of the processing circuit 120 and the function circuit 130 is higher than the heavy load threshold H_TH is not higher than the first predetermined value, the monitoring circuit 110 does not adjust the operation mode of the processing circuit 120 and the function circuit 130. Since the operation modes of the processing circuit 120 and the function circuit 130 are not frequently switched, the power consumption of the control circuit 100A can be reduced.

Similarly, when the duration that the total current of the processing circuit 120 and the function circuit 130 is less than the light threshold value L_TH is higher than a second predetermined value, the monitoring circuit 110 adjusts the operation mode of the processing circuit 120, the function circuit 130, or both to increase the performance of the processing circuit 120, the function circuit 130, or both. However, when the duration that the total current of the processing circuit 120 and the function circuit 130 is lower than the light threshold value L_TH is not higher than the second predetermined value, the monitoring circuit 110 does not adjust the performance of the processing circuit 120 and the function circuit 130.

In other embodiments, the monitoring circuit 110 comprises a storage circuit 111. The storage circuit 111 stores the heavy threshold value H_TH and the light threshold value L_TH. The sources of the heavy threshold value H_TH and the light threshold value L_TH are not limited in the present disclosure. In one embodiment, the processing circuit 120 writes the heavy threshold value H_TH and the light threshold value L_TH to the storage circuit 111.

The invention does not limit how the monitoring circuit 110 adjusts the operation modes of the processing circuit 120 and the function circuit 130. In one embodiment, the monitoring circuit 110 generates a mode signal MOD_CTL to adjust the operation mode of the function circuit 130. In another embodiment, the monitoring circuit 110 generates an interruption signal SI. In such cases, the processing circuit 120 adjusts the operation mode of the function circuit 130 according to the interruption signal SI.

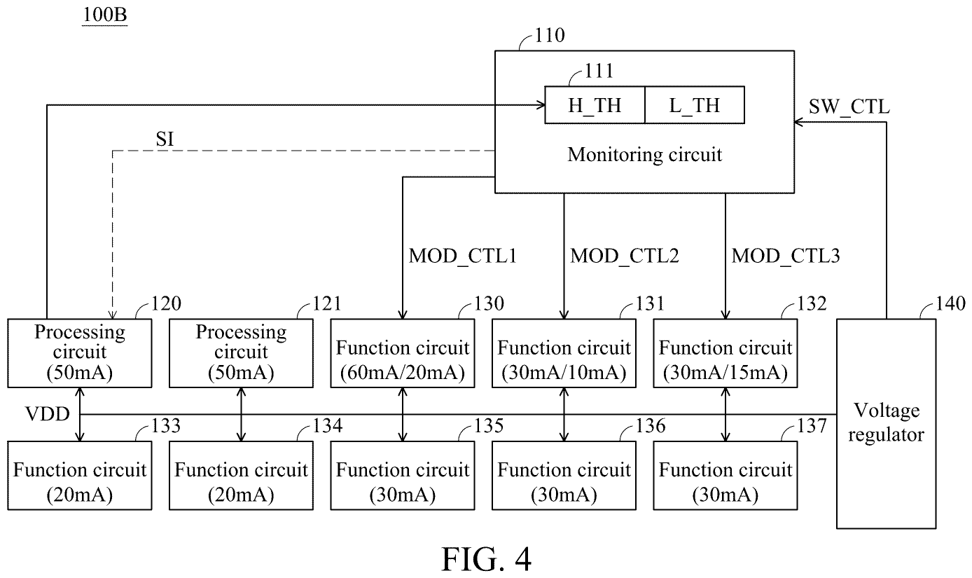

FIG. 4 is a schematic diagram of another exemplary embodiment of the control circuit according to various aspects of the present disclosure. The control circuit 100B comprises a monitoring circuit 110, processing circuits 120 and 121, function circuits 130˜137, and a voltage regulator 140. In one embodiment, the processing circuits 120 and 121 are CPUs, and the function circuit 130 is a computing circuit, such as a neural network processing Unit (NPU).

The invention does not limit the maximum current of the processing circuits 120 and 121, and the function circuits 130˜137. For the brevity, it is assumed that the maximum operating currents of the processing circuits 120 and 121 are 50 mA, the maximum operating currents of the function circuits 133 and 134 are 20 mA, and the maximum operating currents of the function circuits 135˜137 are 30 mA.

Each of the function circuits 130˜132 operates in a performance mode or an energy-saving mode. The monitoring circuit 110 uses the mode signals MOD_CTL1˜MOD_CTL3 to adjust the operation modes of the function circuits 130˜132. Taking the function circuit 131 as an example, when the electrical characteristic of the of the mode signal MOD_CTL2 matches a predetermined state (e.g., a high level), the function circuit 131 operates in a performance mode. In the performance mode, the efficiency (referred to as a third efficiency value) of the function circuit 131 is good and the maximum operating current is 30 mA. When the electrical characteristic of the of the mode signal MOD_CTL2 does not match the predetermined state, the function circuit 131 operates in an energy-saving mode. In the energy-saving mode, the efficiency (referred to as a fourth efficiency value) of the function circuit 131 is low and the maximum operating current is 10 mA.

Assume that the maximum output current of the voltage regulator 140 is 200 mA, the heavy threshold value H_TH is 160, and the light threshold value L_TH is 40. In order to allow the voltage regulator 140 to operate normally, the monitoring circuit 110 controls the operation modes of the function circuits 130˜132 to prevent the output current of the voltage regulator 140 from being greater than 200 mA.

Assume that the processing circuits 120 and 121, and the processing circuits 130˜132 are working in a first period, and the function circuits 130˜132 operate in the performance modes. At this time, if the total current of the processing circuits 120 and 121, and the function circuits 130˜132 is higher than the heavy threshold value H_TH, the monitoring circuit 110 may adjust the operation modes of the function circuits 130˜132 according to a priority order. In one embodiment, the monitoring circuit 110 requires the circuit with lower priority to enter an energy-saving mode. When the total current of the processing circuits 120 and 121, and the function circuits 130˜132 is lower than the light threshold value L_TH, the monitoring circuit 110 requires the circuit with higher priority to enter the performance mode.

For example, assume that the priority of the function circuit 130 is higher than the priority of the function circuit 131, and the priority of the function circuit 131 is higher than the priority of the function circuit 132. When the total current of the processing circuits 120 and 121, and the function circuits 130˜132 is higher than the heavy threshold value H_TH, the monitoring circuit 110 uses the mode signal MOD_CTL3 to request the function circuit 132 to enter an energy-saving mode. If the total current of the processing circuits 120 and 121, and the function circuits 130˜132 is still higher the heavy threshold value H_TH, the monitoring circuit 110 uses he mode signal MOD_CTL2 to request the function circuit 131 to enter an energy-saving mode. If the total current of the processing circuits 120 and 121, and the function circuits 130˜132 is still higher the heavy threshold value H_TH, the monitoring circuit 110 uses the mode signal MOD_CTL1 to request the function circuit 130 to enter an energy-saving mode.

When the total current of the processing circuits 120 and 121, and the function circuits 130˜132 is lower than the light threshold value L_TH, the monitoring circuit 110 uses the mode signal MOD_CTL1 to request the function circuit 130 to enter a performance mode. If the total current of the processing circuits 120 and 121, and the function circuits 130˜132 is still lower than the light threshold value L_TH, the monitoring circuit 110 uses the mode signal MOD_CTL2 to request the function circuit 131 to enter a performance mode. If the total current of the processing circuits 120 and 121, and the function circuits 130˜132 is still lower than the light threshold value L_TH, the monitoring circuit 110 uses the mode signal MOD_CTL3 to request the function circuit 132 to enter a performance mode.

In other embodiments, when the total current of the processing circuits 120 and 121, and the function circuits 130˜137 is higher than the heavy threshold value H_TH or less than the light threshold value L_TH, the monitoring circuit 110 generates an interruption signal SI. The processing circuit 120 switches the operation mode of the function circuits 130˜132 according to the interruption signal SI.

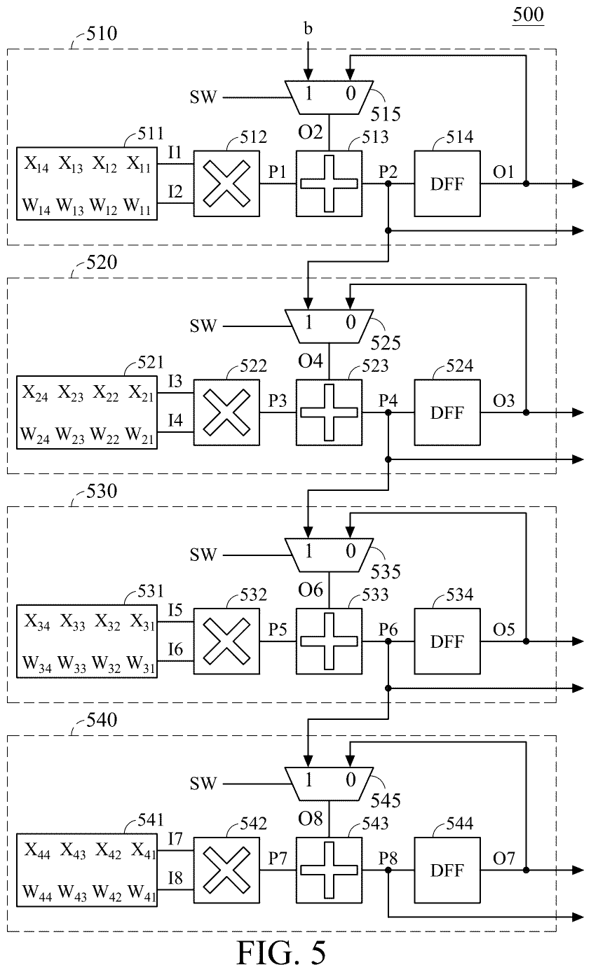

FIG. 5 is a schematic diagram of an exemplary embodiment of a computing circuit according to various aspects of the present disclosure. The computing circuit 500 comprises processing circuits 510, 520, 530, and 540, but the disclosure is not limited thereto. In another embodiment, the computing circuit 500 comprises the more or the fewer processing circuits. In some embodiments, the computing circuit 500 is used as the function circuit 130 of FIG. 1.

The processing circuit 510 comprises a storage circuit 511, a multiplier 512, an adder 513, a D-type flip-flop 514 and a multiplexer 515. The storage circuit 511 provides input values I1 and I2. In one embodiment, the processing circuit 120 writes the input values I1 and I2 to the storage circuit 511. The structure of storage circuit 511 is not limited in the present disclosure. In one embodiment, the storage circuit 511 comprises a plurality of D-type flip-flops to provide the input values I1 and I2 to the multiplier 512. The multiplier 512 generates a processed value P1 by multiplying the input value I1 by the input value I2. The adder 513 adds the processed value P1 to an output value O2 to generate a processed value P2. The D-type flip-flop 514 provides the processed value P2 as an output value O1 according to a clock signal (not shown). The multiplexer 515 provides an external value b or the output value O1 as the output value O2 according to a switching signal SW.

The processing circuit 520 comprises a storage circuit 521, a multiplier 522, an adder 523, a D-type flip-flop 524 and a multiplexer 525. The storage circuit 521 provides input values I3 and I4. Since the characteristic of the storage circuit 521 is similar to the characteristic of the storage circuit 511, the related description is omitted here. The multiplier 522 generates a processed value P3 by multiplying the input value I3 by the input value I4. The adder 523 adds the processed value P3 to an output value O4 to generate a processed value P4. The D-type flip-flop 524 generates an output value O3 according to the processed value P4. The multiplexer 525 provides the processed value P2 or the output value O3 as the output value O4 according to a switching signal SW.

The processing circuit 530 comprises a storage circuit 531, a multiplier 532, an adder 533, a D-type flip-flop 534 and a multiplexer 535. The storage circuit 531 provides input values I5 and I6. Since the characteristic of the storage circuit 531 is similar to the characteristic of the storage circuit 511, the related description is omitted here. The multiplier 532 generates a processed value P5 by multiplying the input value I5 by the input value I6. The adder 533 adds the processed value P5 to an output value O6 to generate a processed value P6. The D-type flip-flop 534 generates an output value O5 according to the processed value P6. The multiplexer 535 provides the processed value P4 or the output value O5 as the output value O6 according to a switching signal SW.

The processing circuit 540 comprises a storage circuit 541, a multiplier 542, an adder 543, a D-type flip-flop 544 and a multiplexer 545. The storage circuit 541 provides input values I7 and I8. Since the characteristic of the storage circuit 541 is similar to the characteristic of the storage circuit 511, the related description is omitted here. The multiplier 542 generates a processed value P7 by multiplying the input value I7 by the input value I8. The adder 543 adds the processed value P7 to an output value O8 to generate a processed value P8. The D-type flip-flop 544 generates an output value O7 according to the processed value P8. The multiplexer 545 provides the processed value P6 or the output value O7 as the output value O8 according to a switching signal SW.

In one embodiment, when the switching signal SW_CTL is in a first level, the computing circuit 500 operates in an energy-saving mode. In the energy-saving mode, the processing circuit 510 works, and the processing circuits 520, 530, and 540 stop working. Therefore, the power consumption of the computing circuit 500 is reduced.

In a first period, the storage circuit 511 serves the operand X₁₁ and the weight value W₁₁ as the input values I1 and I2. The multiplier 512 generates the processed value P1 by multiplying the input value I1 by the input value I2. Since the switching signal SW is in a first level, the multiplexer 515 uses the output value O1 as the output value O2. At this time, the output value O1 is a predetermined value. The adder 513 adds the processed value P1 and the output value O2 to generate the processed value P2. The D-type flip-flop 514 stores the processed value P2.

In a second period, the storage circuit 511 serves the operand X₁₂ and the weight value W₁₂ as the input values I1 and I2. The multiplier 512 generates the processed value P1 by multiplying the input value I1 by the input value I2. Since the switching signal SW is in a first level, the multiplexer 515 uses the output value O1 as the output value O2. At this time, the output value O1 is equal to the processed value P2 of the first period. The adder 513 adds the processed value P1 and the output value O2 to generate the processed value P2. The D-type flip-flop 514 stores the processed value P2.

In a third period, the storage circuit 511 serves the operand X₁₃ and the weight value W₁₃ as the input values I1 and I2. The multiplier 512 generates the processed value P1 by multiplying the input value I1 by the input value I2. Since the switching signal SW is in a first level, the multiplexer 515 uses the output value O1 as the output value O2. At this time, the output value O1 is the same as the processed value P2 of the second period. The adder 513 adds the processed value P1 and the output value O2 to generate the processed value P2. The D-type flip-flop 514 stores the processed value P2.

In a fourth period, the storage circuit 511 serves the operand X₁₄ and the weight value W₁₄ as the input values I1 and I2. The multiplier 512 generates the processed value P1 by multiplying the input value I1 by the input value I2. Since the switching signal SW is in a first level, the multiplexer 515 uses the output value O1 as the output value O2. At this time, the output value O1 is equal to the processed value P2 of the third period. The adder 513 adds the processed value P1 and the output value O2 to generate the processed value P2. The D-type flip-flop 514 stores the processed value P2. In the energy-saving mode, the output value O4 of the D-type flip-flop 514 is served as a calculation result (X₁₁×W₁₁)+(X₁₂×W₁₂)+(X₁₃W₁₃)+(X₁₄×W₁₄)+b.

In another embodiment, when the switching signal SW is in a second level, the computing circuit 500 operates in a performance mode. In the performance mode, the processing circuits 510, 520, 530, and 540 operate simultaneously. Therefore, the performance of the computing circuit 500 is high. In the performance mode, the storage circuit 511 serves the operand X₁₁ and the weight value W₁₁ as the input values I1 and I2. At this time, the storage circuit 521 serves the operand X₂₁ and the weight value W₂₁ as the input values I3 and I4. In addition, the storage circuit 531 serves the operand X₃₁ and the weight value W₃₁ as the input values I5 and I6, and the storage circuit 541 serves the operand X₄₁ and the weight value W₄₁ as the input values I7 and I8.

In the performance mode, the multiplier 512 generates the processed value P1 by multiplying the input value I1 by the input value I2, and the multiplier 522 generates the processed value P3 by multiplying the input value I3 by the input value I4. Furthermore, the multiplier 532 generates the processed value P5 by multiplying the input value I5 by the input value I6, and the multiplier 542 generates the processed value P7 by multiplying the input value I7 by the input value I8.

Since the switching signal SW is in a second level, the multiplexer 515 provides the external value b as the output value O2. The adder 513 adds the processed value P1 and the output value O2 to generate the processed value P2. At this time, the multiplexer 525 provides the processed value P2 as the output value O4. The adder 523 adds the processed value P3 and the output value O4 to generate the processed value P4. The multiplexer 535 provides the processed value P4 as the output value O6. The adder 533 adds the processed value P5 and the output value O6 to generate the processed value P6. The multiplexer 545 provides the processed value P6 as the output value O8. The adder 543 adds the processed value P7 and the output value O8 to generate the processed value P8. At this time, the processed value P8 serves the calculation result of the computing circuit 500. The processed value P8 is b+(I₁×I₂)+(I₃×I₄)+(I₅×I₆)+(I₇×I₈). In the performance mode, the D-type flip-flops 514, 524, 534, and 544 stop working. In other words, the output values O1, O3, O5, and O7 are not provided.

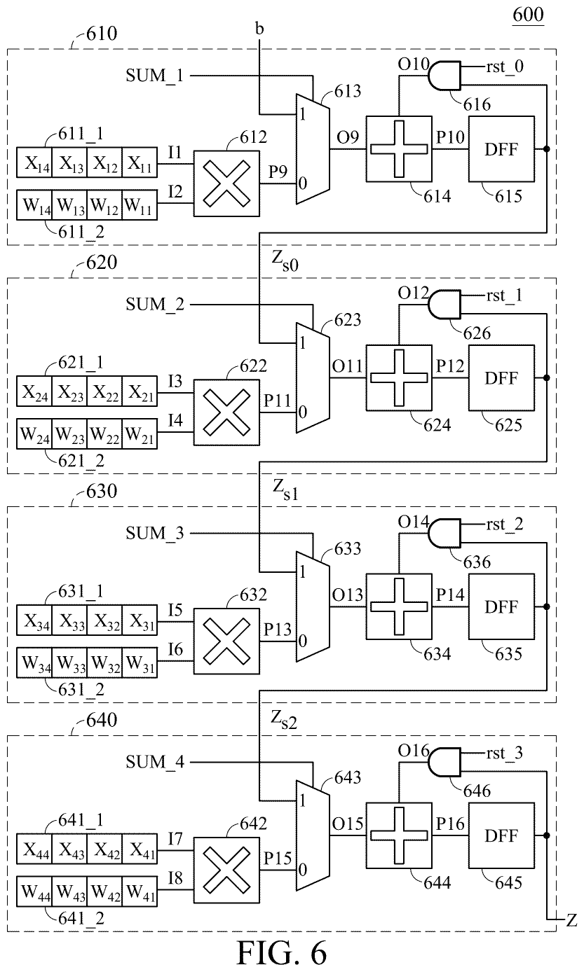

FIG. 6 is a schematic diagram of another exemplary embodiment of the computing circuit according to various aspects of the present disclosure. The computing circuit 600 comprises processing circuits 610, 620, 630, and 640, but the disclosure is not limited in the present disclosure. In other embodiments, the computing circuit 600 comprises the more or the fewer processing circuits. In one embodiment, the computing circuit 600 serves the function circuit 130 of FIG. 1.

The processing circuit 610 comprises storage circuits 611_1 and 611_2, a multiplier 612, a multiplexer 613, an adder 614, a D-type flip-flop 615, and a logic circuit 616. The storage circuit 611_1 stores the operands X¹¹, X¹², X¹³, and X¹⁴ and sequentially uses the operands X¹¹, X¹², X¹³ and X¹⁴ as the input value I1. In one embodiment, the operands X¹¹, X¹², X¹³, and X¹⁴ are written into the storage circuit 611_1 by the processing circuit 120. The structure of the storage circuit 611_1 is not limited in the present disclosure. In one embodiment, the storage circuit 611_1 comprises a plurality of D-type flip-flops. The D-type flip-flops sequentially use the operands X¹¹, X¹², X¹³ and X¹⁴ as input values I1 according to a first clock signal.

The storage circuit 611_2 stores the weight values W₁₁, W₁₂, W₁₃, and W₁₄ and uses the weight values W₁₁, W₁₂, W₁₃ and W₁₄ as the input value I2. In one embodiment, the weight values W₁₁, W₁₂, W₁₃, and W₁₄ are written into the storage circuit 611_2 by the processing circuit 120. The structure of the storage circuit 611_2 is not limited in the present disclosure. In one embodiment, the storage circuit 611_2 comprises a plurality of D-type flip-flops. The D-type flip-flops sequentially use the weight values W₁₁, W₁₂, W₁₃ and W₁₄ as input values I2 according to a second clock signal.

In one embodiment, in a first period, the storage circuit 611_1 sequentially uses the operands X₁₁, X₁₂, X₁₃ and X₁₄ as the input value I1 according to a first clock signal. In the first period, the storage circuit 611_2 uses the weight value W₁₁ as the input value I2 according to a second clock signal. Then, in a second period, the storage circuit 611_1 sequentially re-uses the operands X₁₁, X₁₂, X₁₃ and X₁₄ as the input value I1 according to the first clock signal. In the second period, the storage circuit 611_2 uses the weight value W₁₂ as the input value I2 according to the second clock signal. In a third period, the storage circuit 611_1 sequentially re-uses the operands X₁₁, X₁₂, X₁₃ and X₁₄ as the input value I1 according to the first clock signal. In the third period, the storage circuit 611_2 uses the weight value W₁₃ as the input value I2 according to the second clock signal. In a fourth period, the storage circuit 611_1 sequentially re-uses the operands X₁₁, X₁₂, X₁₃ and X₁₄ as the input value I1 according to the first clock signal. In the fourth period, the storage circuit 611_2 uses the weight value W₁₄ as the input value I2 according to the second clock signal. In such cases, since the storage circuit 611_2 does not need to frequently update the input value I2, the frequency of the second clock signal is lower than the frequency of the first clock signal, and the power consumption of the storage circuit 611_2 is lower.

The multiplier 612 multiplies the input values I1 and I2 to generate a processed value P9. The multiplexer 613 uses an external value b or a processed value P9 as an output value O9 according to a switching signal SUM_1. The adder 614 adds the output value O9 to the output value O10 to generate a processed value P10. The D-type flip-flop 615 uses the processed value P10 as an output value Zs0 according to a clock signal (not shown). For example, when the clock signal is switched from a first level to a second level, the D-type flip-flop 615 uses the processed value P10 as the output value Zs0. The logic circuit 616 generates an output value O10 according to a reset signal rst_0 and the output value Zs0. In this embodiment, the logic circuit 616 is an AND gate.

The processing circuit 620 comprises storage circuits 621_1 and 621_2, a multiplier 622, a multiplexer 623, an adder 624, a D-type flip-flop 625, and a logic circuit 626. The storage circuit 621_1 stores the operands X₂₁, X₂₂, X₂₃, and X₂₄ and sequentially uses the operands X₂₁, X₂₂, X₂₃ and X₂₄ as the input value I3. The storage circuit 621_2 stores the weight values W₂₁, W₂₂, W₂₃, and W₂₄ and uses the weight values W₂₁, W₂₂, W₂₃ and W₂₄ as the input value I4. Since the characteristics of the storage circuits 621_1 and 621_2 are similar to the characteristics of the storage circuits 611_1 and 611_2, the related description is omitted here.

The multiplier 622 multiplies the input values I3 and I4 to generate a processed value P11. The multiplexer 623 uses the output value Zs0 or the processed value P11 as an output value O11 according to a switching signal SUM_2. The adder 624 adds the output value O11 to the output value O12 to generate a processed value P12. The D-type flip-flop 625 uses the processed value P12 as an output value Zs1 according to a clock signal (not shown). Since the characteristic of the D-type flip-flop 625 is similar to the characteristic of the D-type flip-flop 615, the related description is omitted here. The logic circuit 626 generates an output value O12 according to a reset signal rst_1 and the output value Zs1. In this embodiment, the logic circuit 626 is an AND gate.

The processing circuit 630 comprises storage circuits 631_1 and 631_2, a multiplier 632, a multiplexer 633, an adder 634, a D-type flip-flop 635, and a logic circuit 636. The storage circuit 631_1 stores the operands X₃₁, X₃₂, X₃₃, and X₃₄ and sequentially uses the operands X₃₁, X₃₂, X₃₃ and X₃₄ as the input value I5. The storage circuit 631_2 stores the weight values W₃₁, W₃₂, W₃₃, and W₃₄ and uses the weight values W₃₁, W₃₂, W₃₃ and W₃₄ as the input value I6. Since the characteristics of the storage circuits 631_1 and 631_2 are similar to the characteristics of the storage circuits 611_1 and 611_2, the related description is omitted here.

The multiplier 632 multiplies the input values I5 and I6 to generate a processed value P13. The multiplexer 633 uses the output value Zs1 or the processed value P13 as an output value O13 according to a switching signal SUM_3. The adder 634 adds the output value O13 to the output value O14 to generate a processed value P14. The D-type flip-flop 635 uses the processed value P14 as an output value Zs2 according to a clock signal (not shown). Since the characteristic of the D-type flip-flop 635 is similar to the characteristic of the D-type flip-flop 615, the related description is omitted here. The logic circuit 636 generates an output value O14 according to a reset signal rst_2 and the output value Zs2. In this embodiment, the logic circuit 636 is an AND gate.

The processing circuit 640 comprises storage circuits 641_1 and 641_2, a multiplier 642, a multiplexer 643, an adder 644, a D-type flip-flop 645, and a logic circuit 646. The storage circuit 641_1 stores the operands X₄₁, X₄₂, X₄₃, and X₄₄ and sequentially uses the operands X₄₁, X₄₂, X₄₃ and X₄₄ as the input value I7. The storage circuit 641_2 stores the weight values W₄₁, W₄₂, W₄₃, and W₄₄ and uses the weight values W₄₁, W₄₂, W₄₃ and W₄₄ as the input value I8. Since the characteristics of the storage circuits 641_1 and 641_2 are similar to the characteristics of the storage circuits 611_1 and 611_2, the related description is omitted here.

The multiplier 642 multiplies the input values I7 and I8 to generate a processed value P15. The multiplexer 643 uses the output value Zs2 or the processed value P15 as an output value O15 according to a switching signal SUM_4. The adder 644 adds the output value O15 to the output value O16 to generate a processed value P16. The D-type flip-flop 645 uses the processed value P16 as an output value Z according to a clock signal (not shown). Since the characteristic of the D-type flip-flop 645 is similar to the characteristic of the D-type flip-flop 615, the related description is omitted here. The logic circuit 646 generates an output value O16 according to a reset signal rst_3 and the output value Z. In this embodiment, the logic circuit 646 is an AND gate.

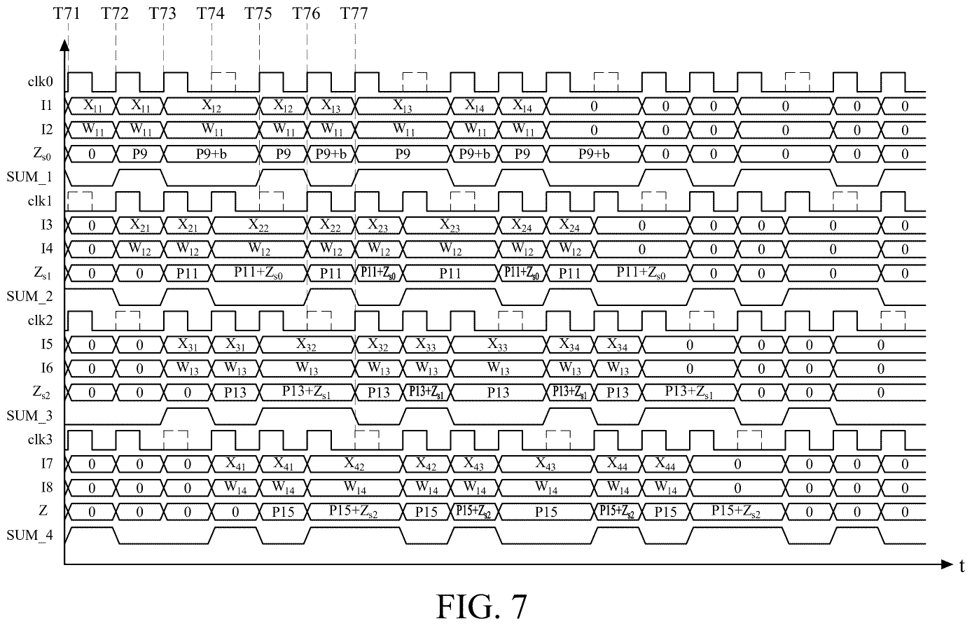

FIG. 7 is a schematic diagram of the operation of the computing circuit according to various aspects of the present disclosure. The symbols clk0˜clk3 are clock signals of the storage circuits 611_1, 621_1, 631_1, and 641_1, respectively. When the clock signal is changed from a low level (referred to as a first level) to a high level (referred to as a second level), the storage circuits 611_1, 621_1, 631_1, 641_1 update the input values I1, I3, I5, and I7 respectively. In some embodiments, the clock signals clk0˜clk3 are respectively used as clock signals of the D-type flip-flops 615, 625, 635, and 645. Since the operations of the processing units 610, 620, 630, and 640 are similar, the processing unit 610 is given as an example.

At time point T71, the clock signal clk0 is changed from the low level to the high level. Therefore, the storage circuit 611_1 uses the operand X₁₁ as the input value I1 and the storage circuit 611_2 uses the weight value W₁₁ as the input value I2. The multiplier 612 multiplies the input values I1 and I2 to generate a processed value P9 (i.e., I1×I2).

At time point T72, since the switching signal SUM_1 is in the high level, the multiplexer 613 uses the external value b as the output value O9. At this time, the reset signal rst_0 may be in a high level. The adder 614 adds the output value O9 to the output value O10 to generate the processed value P10. The D-type flip-flop 615 stores the processed value P10.

At time point T73, since the switching signal SUM_1 is in the low level, the multiplexer 613 uses the processed value P9 as the output value O9. At this time, the reset signal rst_0 may be in a low level. Therefore, the output value O10 is equal to the value 0, At this time, the D-type flip-flop 615 uses the processing value P10 (i.e., (X11×W11) +b) of the previous cycle as the output value Zs0. At this time, the storage circuit 611_1 uses the operand X₁₂ as the input value I1.

At time point T74, since the clock signal clk0 is maintained at the low level, the processing unit 610 stops operating. At time point T75, the clock signal clk0 is changed from the low level to the high level so that the processing unit 610 operates again. At this time, since the clock signal clk1 is maintained at the low level, the processing unit 620 stops operating. At time point T76, the clock signal clk1 is changed from the low level to the high level so that the processing unit 620 operates again. At this time, since the clock signal clk2 is maintained at the low level, the processing unit 630 stops operating. At time point T77, the clock signal clk2 is changed from the low level to the high level so that the processing unit 630 operates again. At this time, since the clock signal clk3 is maintained at the low level, the processing unit 640 stops operating.

By using the clock signals clk0˜clk3 to temporarily shut down at least one processing unit, the power consumption of the computing circuit 600 can be reduced. When more computing units are turned on, the computing circuit 600 has higher performance. When fewer operating units are turned on, the operating circuit 600 has lower power consumption. In addition, since the input value of each multiplier is fixed, even if all the operation units are turned on, the purpose of power saving can still be achieved.

It will be understood that when an element or layer is referred to as being “on”, “connected to” or “coupled to” another element or layer, it can be directly on, connected or coupled to the other element or layer or intervening elements or layers may be present. In contrast, when an element or layer is referred to as be “directly on”, “directly connected to” or “directly coupled to” another element or layer, there are no intervening elements or layers present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control circuit, comprising:
a processing circuit;
a first function circuit operating in a first performance mode or a first energy-saving mode, wherein the first function circuit has a first efficiency value in the first performance mode and has a second efficiency value in the first energy-saving mode, and the first efficiency value is higher than the second efficiency value;
a voltage regulator providing an operating voltage to the processing circuit and the first function circuit and using a switching signal to adjust the operating voltage; and
a monitoring circuit determining a total current of the processing circuit and the first function circuit according to the switching signal,
wherein:
in response to the total current of the processing circuit and the first function circuit being higher than a heavy threshold value, the monitoring circuit directs the first function circuit to operate in the first energy-saving mode,
in response to the total current of the processing circuit and the first function circuit being lower than a light threshold value, the monitoring circuit directs the first function circuit to operate in the first performance mode.

2. The control circuit as claimed in claim 1, wherein the monitoring circuit comprises:
a storage circuit storing the heavy threshold value and the light threshold value,
wherein the processing circuit writes the heavy threshold value and the light threshold value to the storage circuit.

3. The control circuit as claimed in claim 1, further comprising:
a second function circuit operating in a second performance mode or a second energy-saving mode, wherein the second function circuit has a third efficiency value in the second performance mode and has a fourth efficiency value in the second energy-saving mode, and the third efficiency value is higher than the fourth efficiency value; and
a third function circuit operating in a third performance mode or a third energy-saving mode, wherein the third function circuit has a fifth efficiency value in the third performance mode and has a sixth efficiency value in the third energy-saving mode, and the fifth efficiency value is higher than the sixth efficiency value,
wherein:
in response to a total current of the processing circuit, the first function circuit, the second function circuit, and the third function circuit being higher than the heavy threshold value, the monitoring circuit directs the second function circuit to operate in the second energy-saving mode,
after the second function circuit operates in the second energy-saving mode:
in response to the total current of the processing circuit, the first function circuit, the second function circuit, and the third function circuit being higher than the heavy monitoring circuit, the monitoring circuit directs the third function circuit to operate in the third energy-saving mode,
in response to the total current of the processing circuit, the first function circuit, the second function circuit, and the third function circuit being lower than the heavy threshold value and higher than the light threshold value, the monitoring circuit stops adjusting operation modes of the first function circuit, the second function circuit, and the third function circuit.

4. The control circuit as claimed in claim 3, wherein:
after the second function circuit operates in the second energy-saving mode and the third function circuit operates in the third energy-saving mode:
in response to the total current of the processing circuit, the first function circuit, the second function circuit, and the third function circuit being lower than the light threshold value, the monitoring circuit directs the third function circuit to operate in the third performance mode,
after the third function circuit operates in the third performance mode, in response to the total current of the processing circuit, the first function circuit, the second function circuit, and the third function circuit being lower than the light threshold value, the monitoring circuit directs the second function circuit to operate in the second performance mode,
after the third function circuit operates in the third performance mode and the second function circuit operates in the second performance mode, in response to the total current of the processing circuit, the first function circuit, the second function circuit, and the third function circuit being lower than the light threshold value, the monitoring circuit directs the first function circuit to operate in the first performance mode.

5. The control circuit as claimed in claim 4, wherein:
the monitoring circuit generates a first mode signal, a second mode signal, and a third mode signal according to the total current of the processing circuit, the first function circuit, the second function circuit, and the third function circuit,
the first function circuit operates in the first performance mode or the first energy-saving mode according to the first mode signal,
the second function circuit operates in the second performance mode or the second energy-saving mode according to the second mode signal, and
the third function circuit operates in the third performance mode or the third energy-saving mode according to the third mode signal.

6. The control circuit as claimed in claim 4, wherein the monitoring circuit generates an interruption signal according to the total current of the processing circuit, the first function circuit, the second function circuit, and the third function circuit, and the processing circuit switches the operation modes of the first function circuit, the second function circuit, and the third function circuit according to the interruption signal.

7. The control circuit as claimed in claim 1, wherein in response to the switching signal being changed from a first level to a second level, the monitoring circuit determines the total current of the processing circuit and the first function circuit according to the duration of the switching signal being at the second level.

8. The control circuit as claimed in claim 7, wherein the voltage regulator comprises a pulse-width modulation circuit.

9. The control circuit as claimed in claim 1, wherein the monitoring circuit determines the total current of the processing circuit and the first function circuit according to the number of times that the switching signal is changed from a first level to a second level in fixed time interval.

10. The control circuit as claimed in claim 9, wherein the volage adjustment circuit comprises a pulse-frequency modulation circuit or a pulse-skip modulation circuit.

11. The control circuit as claimed in claim 1, wherein the voltage regulator comprises:
a transmission circuit determining whether to transmit an input voltage to a node according to the switching signal;
an energy storage circuit coupled to the node, storing the operating voltage according to the voltage node, and providing the operating voltage to the processing circuit and the first function circuit; and
a signal generating circuit generating the switching signal according to the operating voltage.

12. A computing circuit, comprising:
a first multiplier generating a first processed value by multiplying a first input value by a second input value;
a first multiplexer providing an external value or a first output value as a second output value;
a first adder adding the first processed value to the second output value to generate a second processed value;
a first D-type flip-flop generating the first output value according to the second processed value;
a second multiplier generating a third processed value by multiplying a third input value by a fourth input value;
a second multiplexer providing the second processed value or a third output value as a fourth output value;
a second adder adding the third processed value to the fourth output value to generate a fourth processed value; and
a second D-type flip-flop generating the third output value according to the fourth processed value,
wherein:
in response to the first multiplexer providing the external value as the second output value, the second multiplexer provides the second processed value as the fourth output value and the first D-type flip-flop and the second D-type flip-flop stop working,
in response to the first multiplexer providing the first output value as the second output value, the second multiplexer provides the third output value as the fourth output value.

13. A computing circuit, comprising:
a first input circuit outputting a first input value and a first weight value according to a first clock signal;
a first multiplier generating a first processed value by multiplying the first input value by a first weight value;
a first multiplexer providing an external value or the first processed value as a first output value;
a first adder adding the first output value to a second output value to generate a second processed value;
a first D-type flip-flop generating a third output value according to the second processed value;
a first logic circuit generating the second output value according to a first reset signal and the third output value;
a second input circuit outputting a second input value and a second weight value according to a second clock signal;
a second multiplier generating a third processed value by multiplying the second input value by the second weight value;
a second multiplexer providing the third output value or the third processed value as a fourth output value;
a second adder adding the fourth output value to a fifth output value to generate a fourth processed value;
a second D-type flip-flop generating a sixth output value according to the fourth processed value; and
a second logic circuit generating the fifth output value according to a second reset signal and the sixth output value.

14. The computing circuit as claimed in claim 13, wherein:
in a first processing period, the first input value is a first value, and the first weight value is a second value.
In a second processing period, the first input value is a third value, and the first weight value is the second value.

15. The computing circuit as claimed in claim 13, wherein:
at a first time point, the first clock signal and the second clock signal are changed from a first level to a second level,
at a second time point, the first clock signal is fixed at the first level and the second clock signal is changed from the first level to the second level, and
at a third time point, the first clock signal is changed from the first level to the second level and the second clock signal is fixed at the first level.

16. The computing circuit as claimed in claim 15, wherein in response to the first clock signal being changed from the first level to the second level, the first D-type flip-flop provides the second processed value as the third output value.

17. The computing circuit as claimed in claim 13, further comprising:
a third input circuit outputting a third input value and a third weight value according to a third clock signal;
a third multiplier generating a fifth processed value by multiplying the third input value by the third weight value;
a third multiplexer providing the sixth output value or the fifth processed value as a seventh output value;
a third adder adding the seventh output value to an eighth output value to generate a sixth processed value;
a third D-type flip-flop generating a ninth output value according to the sixth processed value; and
a third logic circuit generating the eighth output value according to a third reset signal and the ninth output value.

18. The computing circuit as claimed in claim 17, wherein each of the first logic circuit, the second logic circuit, and the third logic circuit is an AND gate.

19. The computing circuit as claimed in claim 17, wherein:
at a first time point, the first clock signal, the second clock signal, and the third clock signal are changed from a first level to the second level,
at a second time point, the first clock signal is fixed at the first level, and the second clock signal and the third clock signal are changed from the first level to the second level,
at a third time point, the first clock signal and the third clock signal are changed from the first level to the second level, and the second clock signal is fixed at the first level, and
at a fourth time point, the third clock signal is fixed at the first level, and the first clock signal and the second clock signal are changed from the first level to the second level.

20. The computing circuit as claimed in claim 19, wherein:
in a first processing period, the first input value is a first value and the first weight value is a second value, and
in a second processing period, the first input value is a third value and the first weight value is the second value.
